(19) United States
(12) Patent Application Publication
(10) Pub. No.: US 2009/0289577 A1
(43) Pub. Date: Nov. 26, 2009

(54) CONTROL OF BATH WATER COLOR WITH LIGHT

(75) Inventors: Paul Philip Thursfield, Eindhoven (NL); Gerard Francis Harkin, Eindhoven (NL); Bartel Marinus Van De Sluis, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/302,038

(22) PCT Filed: Jun. 8, 2007
(86) PCT No.: PCT/IB07/52178

§ 371 Date: Nov. 24, 2008

(30) Foreign Application Priority Data
Jun. 9, 2006 (EP) 06115197.3

(51) Int. Cl. H05B 37/02

(52) U.S. Cl. 315/294; 362/231; 362/101

(57) ABSTRACT

The invention provides a sanitary arrangement with a vessel for a liquid, wherein the vessel further comprises light sources to illuminate the liquid received in the vessel. The illumination colors of the vessel light sources are controllable. The arrangement further comprises a liquid source for a jet of liquid to fill the vessel. The liquid source comprises light sources to illuminate the jet of liquid from the liquid source. The illumination color of these light sources is also controllable. A control unit is provided to control the one or more vessel illumination colors of the vessel light sources. The illumination color of the vessel light sources has a relationship with the illumination color of the light sources of the liquid source.

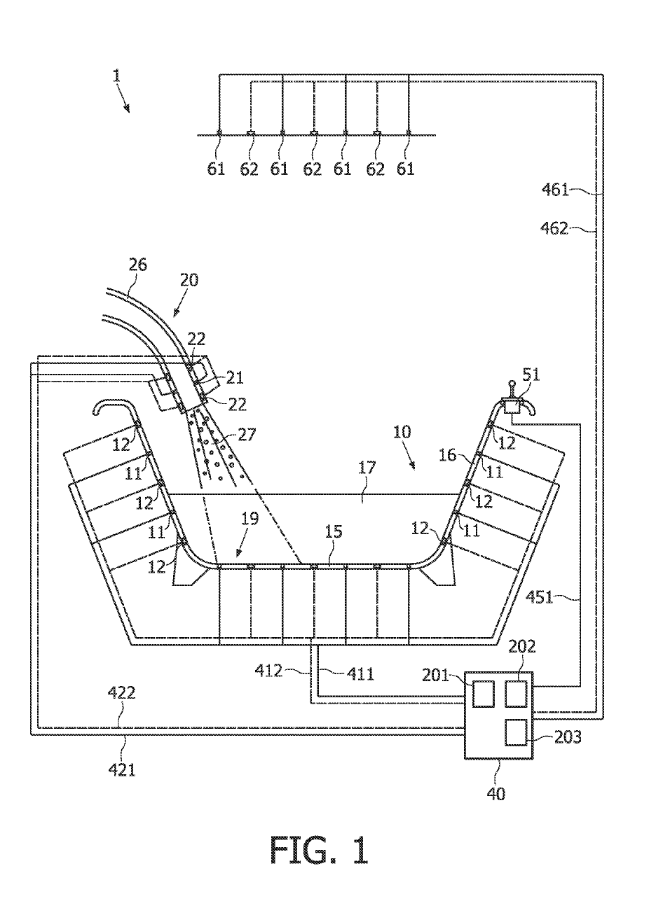

### FIELD OF THE INVENTION

The invention relates to a sanitary arrangement comprising a vessel arranged to receive a liquid, especially water, and a liquid source, which sanitary arrangement comprises a plurality of vessel light sources to illuminate the liquid with one or more illumination colors. The invention further relates to a method for controlling one or more vessel illumination colors of the plurality of vessel light sources, as well as a control unit therefor. The invention also relates to a computer program product for performing this method.

### BACKGROUND OF THE INVENTION

Illumination systems to illuminate bath water are known from the art. For instance, U.S. Pat. No. 6,539,561 provides an illumination device on the back surface side of a bathtub vessel for receiving water, formed of a transparent material or a translucent material. The bathtub unit has a double-hulled structure consisting of an inner vessel and an outer vessel, the inner vessel being formed of a transparent material or a translucent material, and an illumination device is provided in a space between the inner vessel and the outer vessel. The illumination device may be a liquid crystal display for displaying color images, a lamp, or a light emitting diode.

U.S. Pat. No. 6,936,978 discloses methods and apparatus for remotely controlled illumination of liquids in a variety of environments. In one example of U.S. Pat. No. 6,936,978, remotely controlled multi-color LED-based light sources are employed to achieve a wide range of enhanced lighting effects in liquids. In another example of this document, a pool or spa is illuminated by one or more remotely controlled multicolor light sources that may be employed as individually and independently controllable devices, or coupled together to form a remotely controlled networked lighting system to provide a variety of programmable and/or coordinated color illumination effects in the pool or spa environment.

### SUMMARY OF THE INVENTION

A disadvantage of the bathing arrangements of the prior art is that the color of the bath water cannot be changed easily and dynamically, and an intuitive way of controlling the bath water lighting and especially the bath water lighting color is not possible.

Hence, it is an aspect of the invention to provide an alternative sanitary arrangement which preferably provides the possibility of an intuitive way of controlling bath water lighting and especially bath water lighting color. It is a further aspect of the invention to provide a control unit for use in such a sanitary arrangement, as well as a method and a computer program product for controlling the bath water lighting color.

According to a first aspect of the invention, there is provided a sanitary arrangement comprising:
a vessel arranged to receive a liquid;
the vessel comprising a plurality of vessel light sources configured to illuminate the liquid received in the vessel, the plurality of vessel light sources providing light of one or more vessel illumination colors, and the vessel source illumination colors of the plurality of vessel light sources being controllable;
a liquid source, arranged to provide a jet of liquid to the vessel; the liquid source comprising one or more liquid source light sources configured to illuminate the jet of liquid from the liquid source, the one or more liquid source light sources providing light of a liquid source illumination color, and the liquid source illumination color of the one or more liquid source light sources being controllable;
a control unit configured to control the one or more vessel illumination colors of the plurality of vessel light sources, the illumination colors of the plurality of vessel light sources having a relationship with the illumination color of the one or more liquid source light sources.

According to another aspect of the invention, a control unit according to claim 8 is provided. According to yet other aspects of the invention, a method for controlling one or more illumination colors of the plurality of vessel light sources according to claim 10, as well as a computer program product according to claim 13 for performing this method according to the invention, are provided.

### BRIEF DESCRIPTION OF THE DRAWINGS

Embodiments of the invention will now be described, by way of example only, with reference to the accompanying schematic drawing in which corresponding reference symbols indicate corresponding parts, and in which the drawing schematically depicts a sanitary arrangement according to the invention, including some optional variations, said sanitary arrangement comprising a bath as the vessel and a tap as the liquid source.

### DESCRIPTION OF PREFERRED EMBODIMENTS

The drawing schematically shows an embodiment of a sanitary arrangement 1 according to the invention. The sanitary arrangement comprises a vessel 10 arranged to receive a liquid 17. The liquid preferably comprises water, such as tap water, but may also comprise other types of liquid like flushing water, spa water, etc. Preferably, the liquid is water, such as water from a tap.

### Vessel

Vessel 10 arranged to receive liquid 17 may be selected from the group consisting of a shower basin, a bath (or bathtub), a wash basin (or basin, sink, washbowl, etc.), a bidet and a lavatory (toilet bowl). Vessel 10 is arranged to receive liquid 17 from a liquid source 20 (see also below).

Vessel 10 comprises a plurality of vessel light sources 12 configured to illuminate the liquid 17 received in vessel 10, the plurality of vessel light sources 12 providing light of one or more vessel illumination colors, and the vessel source illumination colors of the plurality of vessel light sources 12 being controllable. As shown in the drawing (front view), the vessel 10 may have a bottom 15 and sides 16 for containing the liquid from liquid source 20. The vessel light sources 12 may be any source suitable for lighting or illuminating liquid 17 in vessel 20. Preferably, the vessel light sources 12 are integrated in the wall or the bottom or in both the wall and the bottom. Configurations are known from the art, such as U.S. Pat. No. 6,539,561. Optionally, also external light sources may be used, for instance above vessel 10. Such light sources are indicated with reference numbers 62 and are preferably used in combination with vessel light sources 12. The vessel light sources 12 may be any light sources suitable for this application, and may be integrated in the wall(s) 16 and/or bottom 15, or may be present behind wall 16 and/or bottom 15; for instance, in an embodiment they may be arranged behind transparent or translucent parts of wall 16 and/or bottom 15, as will be clear to the person skilled in the art. Vessel light sources 12 may be selected from incandescent light sources, high pressure light sources, discharge light sources (such as Xe discharge light sources equipped with luminescent material, as known in the art), luminescent lamps, LCD displays (for instance for displaying light images) and especially LEDs (light emitting devices). The illumination color of the vessel light sources 12 may be controllable by using for instance color filters, or by using sources with different luminescent materials (luminescing at different wavelengths of the visible spectrum) or by using multicolor LEDs, as is known to the person skilled in the art (see also below).

Different illumination colors of the vessel light sources 12 and different colors for the liquid source light source(s) 22 (see below) can be chosen via different mechanisms known in the art. For instance, multicolor LEDs can be used, such that different types of colors can be selected. However, alternatively or in addition, it is possible that within the plurality of vessel light sources 12, a part of the total number of vessel light sources produce light of a first color, a part of the total number of vessel light sources produce light of a second color, different from the first color, etc. Two or more different colors can be used, for instance 2, 3 or 4 sources generating different colors can be used. By selecting the right color filters (for instance using a kind of color wheel), different types of luminescent materials, different types of LEDs or multicolor LEDs etc., a substantial part of the colors within the CIE (Commission Internationale de l'Eclairage) color triangle may be selected by using the principle of color mixing known from CRT (cathode ray tubes), fluorescent lighting, multicolor LED lighting or LED-phosphor lighting, as known to the person skilled in the art. The colors may be selected from blue, green, yellow, orange, red, white, magenta, cyan, etc. Notwithstanding the fact that the plurality of vessel light sources 12 and the one or more liquid source light sources 22 will in general produce visible light, i.e. light with a wavelength or wavelength range selected from the wavelength range between about 400 and 800 nm, a number of vessel light sources 12 (or external light sources 62) may (also) generate UV or IR light, for instance for curative reasons.

The term, a “plurality of vessel light sources 12” refers to the fact that vessel 10 will usually comprise a number of light sources, for instance 5 or more, preferably at least 10. The plurality of vessel light sources 12, of which the illumination colors are controllable, refers to multicolor sources (such as a LED having a red, a blue and a green emitting region) and combination(s) of sources, which combinations can be used to control the illumination color (such as individual LEDs, having red, blue and green emission colors, respectively). The phrase a “plurality of vessel light sources 12, of which the illumination colors are controllable” does not exclude that the vessel 10 may comprise sources, of which the light is not controllable by control unit 40 or of which illumination color(s) do not have a relationship with the illumination color(s) of the light sources 12 indicated as “plurality of vessel light sources 12”.

### Liquid Source

The sanitary arrangement 1 further comprises liquid source 20, arranged to provide a jet of liquid 27 to vessel 10. Liquid source 20 comprises one or more liquid source light sources 22 configured to illuminate the jet of liquid 27 from the liquid source 20, the one or more liquid source light sources 22 providing light of a liquid source illumination color, and the liquid source illumination color of the one or more liquid source light sources 22 being controllable. The terms “jet of liquid 27” or “liquid jet 27” may refer to liquid flowing from a source 20 like a tap, a shower head, etc., but may also refer to the liquid flowing in part of the source 20. For instance, taps are known in the art that have a (for instance horizontal) channel for the liquid with an open or transparent top of the channel, such that a user may view the liquid 27 flowing through source 20. The liquid jet flowing through source 20, which may or may not be at least partially transparent, is also comprised in the term “liquid jet 27” or “jet of liquid 27”. The term “jet” may also include the terms “flow” (i.e. “liquid flow”) or “stream” (i.e. “liquid stream”), as will be clear to the person skilled in the art.

The term “liquid source 20” docs not only include a single source providing a jet of water 27, but may also refer to a plurality of liquid sources 20. For instance one may consider a number of shower heads, one or more taps (liquid sources) for cold and one or more taps (liquid sources) for hot water, etc.

The term, “one or more liquid source light sources 22” refers to the fact that liquid source 20 will usually comprise a number of light sources, for instance 2 or more, preferably at least 5, preferably of the LED type. Herein, the embodiments are described wherein the one or more liquid source light sources 22 are configured (and, in an embodiment, controlled, see below) to provide the liquid source illumination color. Preferably, in case the liquid source light source 22 comprises more than one light source 22, the light sources that are selected to illuminate the liquid 27 substantially illuminate in the same color. For instance, when white light is selected as the color to illuminate liquid jet 27, a filterless position of the filter wheel may be selected for all the (white light emitting) light sources 22 that illuminate the liquid. Or, in another embodiment, when multicolor LEDs are used, each multicolor LED may for instance provide a combination of blue and yellow light (in order to provide white light). In yet another embodiment, a yellow light emitting phosphor coated onto a blue light emitting LED may be used to provide light. The filter wheel or LEDs or multicolor LEDs that are addressed are those that give the desired type of light. Choosing another color, i.e. another wavelength or wavelength range, may imply turning the filter wheel to another position (with another color filter in front of the light source(s)) or addressing other LEDs. For instance, source 20 may comprise a number of LEDs, each LED or each set of LEDs being configured to provide a different emission color.

Different illumination colors of the liquid source light source(s) 22 can be chosen via different mechanisms known in the art, as also described above for the vessel light sources 12. Embodiments for selecting colors described above for vessel light sources 12 and liquid source light sources 22 may be used for both types of sources (i.e. 12 and 22, respectively).

Preferably, light sources 12 configured to illuminate water 17 are essentially not configured to illuminate jet 27, and vice versa (i.e. light sources 22 configured to illuminate jet 27 are essentially not configured to illuminate water 17).

### Control Unit

Further, sanitary arrangement 1 comprises a control unit 40 configured to control the one or more vessel illumination colors of the plurality of vessel light sources 12, the illumination colors of the plurality of vessel light sources 12 having a relationship with the illumination color of the one or more liquid source light sources 22. Preferably, the relationship is based on additive or subtractive color mixing.

### Specific Embodiments

The embodiments described below in more detail are especially directed to a bath (tub) as vessel 10 with a tap as water source 20. However, the terms bath, tap and water do not refer only to such specific embodiments, but also to the general embodiments of a vessel 10 and liquid source 20.

The bath tap 20 has one or more embedded light(s) 22 with color capabilities so that the tap water 27 can be set to the desired color of the visible spectrum. The selection of the lighting to color the tap water 27 can be done in many ways as described above: a color wheel, a separate touch pad (for instance on the tap, or elsewhere, see below) or a remote control device (see also below). The bath 10 has lighting as described above and/or as disclosed in for instance U.S. Pat. No. 6,539,561 or U.S. Pat. No. 6,936,978. The bath lighting with one or more vessel lighting sources 12 is used to color the bath water 17 received from the tap 20. The selection of the lighting color of the bath water 17 can also be done in many ways: a separate touch pad on the bath or a remote control device (see also below). As mentioned above, the bath lighting color has a relationship with the tap lighting color.

This relationship may in an embodiment be based on an adjustment effect (such as a synchronization effect), i.e. that when selecting or changing the liquid source light source color, the color with which water 17 in bath 10 is illuminated is selected or changed likewise. This means that the wavelength or wavelength distribution of the light of vessel sources 12 is substantially the same or (immediately) follows the change in emission wavelength or wavelength distribution, respectively, of the light emitted by the tap light sources 22. For instance, selecting blue light as the illumination light of the one or more liquid source light sources 22, implies that at least part of the total number of vessel light sources 12 also illuminate blue light or gradually change their illumination color to blue light. The control unit 40 is configured to control the one or more vessel illumination colors of the plurality of vessel light sources 12 according to a predetermined relationship. As mentioned above, this may be a synchronization relationship. Synchronization may however also imply that there is a delay or that there is a gradual change to the liquid source illumination color. For instance, if white light is generated as illumination light by both the vessel light sources 12 and the liquid source light sources 22, changing the tap water light color (i.e. illumination light color of the one or more liquid source light sources 22) to blue may mean in an embodiment that a part of the total number of vessel light sources 12 start generating blue light and the intensity of the blue illumination light of the vessel light sources 12 is gradually increased by gradually increasing the number of vessel light sources 12 that switch from white light to blue light. Instead of or in addition to this effect, the intensity of the (blue) illumination light of each individual light source 12 of at least part of the total number of vessel light sources 12 may be increased with time. For instance, in an embodiment, a user may open a tap 20 and select a certain color (for instance blue) for the tap water 27. As the bath 10 begins to fill, the lighting in bath 10 dynamically changes to the blue color of the tap water. This gives the amazing effect that the bath is 10 being filled with blue-lit water 17 (“filling effect”).

The color of the tap water 27, i.e. the illumination color of liquid source light source(s) 22, may be selected in a number of ways. In one embodiment, the color of the tap water is selected using mechanical means, for instance a mechanism that is used to tune by hand one or more color wheels. In another embodiment, an independent touch pad may be used. In those cases, the liquid source 20 preferably further comprises one or more sensors 21 to obtain liquid source sensing input signals, the one or more liquid source sensors 21 being configured to sense the color of the one or more liquid source light sources 22, and optionally also the illumination intensity of the liquid source light sources 22. An input signal generated by the sensors is sent to control unit 40 (for instance via signal carrier 421, which may be a contact wire, but this may also take place wirelessly). Control unit 40 is arranged to control the one or more vessel illumination colors of the plurality of vessel light sources 12 and optionally to control the intensity of the illumination from the plurality of vessel light sources 12 in dependence on the one or more liquid source sensing input signals of one or more liquid source sensors 21.

In another embodiment, however, sanitary arrangement 1 according to the invention further comprises a user input device 51, configured to receive a user input signal for controlling the liquid source illumination color. This user input device 51 may be located on the tap (liquid source) 20, next to the tap, on top of the bath wall 16, or in any other suitable place. User input device 51 may also be wireless. The input signal generated by the user input device 51 as a result of the data (such as “on”, “off, “color”, intensity”, “random color selection”, etc., see also below) given by the user is sent, in an embodiment, via a data carrier (which may be wireless) directly to the liquid source light sources 22 (this embodiment is not depicted) or, in another embodiment, via data carrier 451 (which includes wireless communication) to the control unit 40, which in its turn generates an output signal, for instance via data carrier 422 (dashed line) to liquid source light sources 22. In the former embodiment, one or more liquid source sensors 21 may still be used to sense the illumination color of the liquid source light sources 22, and send a sensing signal to control unit 40, which then controls the illumination color of the plurality of vessel light sources 12 (and optionally the intensity). User input device 51 may for instance comprise one or more touch pads, such as known in the art. User input device 51 may also be configured to send an input signal via carrier 451 to control unit 40 for selecting the type of relationship (for instance “additive color mixing” or “subtractive color mixing”), the speed of synchronization (for instance “slow”, “medium”, “quick”), intensity of the lighting from vessel light sources 12 and/or liquid source light sources 22, etc.

Likewise, user input device 51 may also be configured to generate a user input signal for controlling the vessel source illumination color(s) of the plurality of vessel light sources 12, and optionally the (individual) intensities of the light sources 12 of the plurality of light sources 12.

Hence, the phrase “wherein the illumination colors of the plurality of vessel light sources 12 have a relationship with the illumination color of the one or more liquid light sources 22” may refer to a static color distribution and to a dynamic color distribution. For instance, the illumination color of the liquid source light sources 22 is selected to be a first color with a first wavelength or wavelength distribution (for instance selected with an independent touch pad or mechanical means, input device 51, or randomly selected by control unit 40) and the illumination color of at least part of the vessel light sources 12 is selected to be a second color with a second wavelength or wavelength distribution, different from the first color (for instance selected with an independent touch pad or mechanical means, input device 51, or randomly selected by control unit 40). Then, there may be a relationship in color in that source(s) 12 in vessel 10, which is (are) arranged close to the position where liquid 27 drops, flows or jets into vessel 10 (i.e. those light sources 12 that are arranged in the direction of jet 27, as indicated with area 19) will illuminate a color with a wavelength or wavelength distribution spectrally more close or even identical to the illumination color of the liquid source light source(s) 22, whereas the wavelength or wavelength distribution of vessel light sources 12 may gradually shift to the wavelength or wavelength distribution of the second color with decreasing distance from the former light source(s) 12. Light sources 12 remote from area 19 may illuminate with the wavelength or wavelength distribution of the second color. As the distance to light source(s) 12 arranged within area 19 decreases, the illumination color may (gradually) change from the wavelength or wavelength distribution of the second color to the wavelength or wavelength distribution of the first color. The gradual shift may be based on additive or subtractive color mixing. Hence, the phrase “wherein the illumination colors of the plurality of vessel light sources 12 have a relationship with the illumination color of the one or more liquid light sources 22”, in an embodiment, refers to the configuration wherein at least part of the plurality of light sources 12 have an illumination color substantially identical to the liquid source illumination color (first color), at least part of the plurality of light sources 12 have an illumination color (or illumination colors) substantially different from the liquid source illumination color (second color(s)) and at least part of the plurality of light sources 12 have an illumination color in between (i.e. intermediate colors). These colors may have a relationship based on additive or subtractive color mixing.

This may be a static situation, but this may also be a dynamic situation (synchronization effect), for instance to obtain the above mentioned “filling effect”. Hence, there may be configurations wherein the one or more illumination colors of the vessel light sources 12 are substantially different from the illumination color of the liquid source light source(s) 22, which configurations may, in an embodiment, gradually change to the above described configuration with at least two substantially different colors and intermediate colors. This configuration (“filling pattern”) may be maintained, but may also change to a configuration wherein the illumination colors of the vessel light sources 12 are substantially the same as the illumination color of the liquid source light source(s) 22. In a specific embodiment, the user may control the speed of the change of one configuration into the other. Hence, the phrase “wherein the illumination colors of the plurality of vessel light sources 12 have a relationship with the illumination color of the one or more liquid light sources 22” does not only refer to a configuration wherein all vessel light sources 12 of the plurality of vessel light sources 12 have substantially the same color but may also refer to a configuration wherein part of the total number of vessel light sources 12 have substantially the same color as the one or more liquid source light sources 22 while others emit light of a color different from the color of the one or more liquid light sources 22.

The phrase “in the direction of jet 27” may further be illustrated by assuming an empty vessel 10 having a dry internal surface of walls 16 and/or bottom 15. This internal surface is the surface that is directed to liquid 17 when the vessel 10 is filled. When the vessel starts being filled, those light sources 12 that will be wetted first by the liquid from jet 27 are considered the light sources 12 that are in the direction of jet 27. In the drawing this is schematically indicated with area 19. Area 19 is the area on the bath wall 16 and/or bath bottom 15 to which liquid source 20 direct its jet(s) of liquid 27. This is schematically indicated in the drawing by the area on the bottom (although this may of course also include the wall or part of the wall 16) which is enclosed by the dashed lines. Since, in an embodiment, the light sources 12 that are arranged in the direction of jet 27 may depend upon the flux of water, one or more sensors 21 of liquid source 20 may preferably be configured to generate and send a sensor input signal to control unit 40 (via data carrier 421), such that the control unit 40, based on the executable instructions, may send an output signal to the plurality of light sources 12 in vessel 10 for controlling the illumination color and optionally the illumination intensity of the plurality of vessel light sources 12, i.e., for instance, controlling the light sources 12 in such a way that the light sources in the direction of jet of liquid 27 have an illumination color that is substantially the same as, or change to an illumination color that is substantially the same as, the illumination color of the liquid source light sources 22, whereas light sources 12 more remote than the light sources 12 in the direction of the jet 27 may have an illumination color substantially different from this color. In this way a filling effect may be provided, and the illumination colors of the vessel light source 12 may gradually synchronize with the illumination color of the liquid source light sources 22. The phrase “in the direction of” can also be interpreted as “in line with”. This does not exclude embodiments wherein the jet may be curved, as will be clear to the person skilled in the art.

The tap 20 may in addition to, or instead of, the above mentioned sensors 21 for sensing the illumination color of the liquid source light sources 22 further comprise one or more sensors 21 configured to sense, inter alia, the liquid flux of the liquid source 20. Based on the input data generated by one or more of these sensors 21, control unit 40 may control the illumination color and intensity of the vessel light sources 12. The data generated by the flow sensor(s) 21 may be used as input signal for the controller to be input to the control logarithms (executable instructions) that regulate the bath lighting. For instance, in an embodiment, the lighting of the bath is adapted according to both the color of the tap water 27 (i.e. the illumination color of the one or more liquid source light sources 22) and the volume of tap water 27 entering bath 10 (i.e. the flux). If the color of the tap water is changed, then the bath water color (i.e. the illumination color of the vessel light sources 12) changes based on a certain color mixing algorithm. This mixing algorithm may be based on paint mixing (subtractive: blue+yellow=green) or light mixing (additive: blue+yellow=white). As will be clear to the person skilled in the art, the adjustment (synchronization) of the illumination color of the plurality of vessel light sources 12 to the illumination color of the one or more liquid source light sources 22 implies that at least part of the plurality of vessel light sources 12 follow the color (change(s)) of the illumination color of the liquid source light sources 22. This number may (gradually) increase with time, and/or the illumination intensity thereof may (gradually) increase with time, in order to provide the above described “filling effect”.

Each light source 12 of the plurality of vessel light sources 12 may be individually addressed, for instance, to create the amazing impression of the water color spreading out within the bath. In this way, the invention may provide an intuitive way of controlling the bath water lighting and especially the bath water lighting color.

It may be preferred that the bathtub lighting 12, i.e. in fact control unit 40, is aware of the location of the tap 20. This may be a fixed position for more advanced arrangements 1, wherein all elements are provided as one configuration. When the tap 20 has no fixed position relative to the bath 10 (for instance the position of the bath and the position of the tap may be variable as independent components), i.e. the position of the liquid source 20 relative to the vessel 10 is not fixed, the position of the tap 20 may be an input value for a processor 203 (implemented in the executable instructions) of the control unit 40, which may be entered during or after installation of the vessel 10 and/or liquid source 20, or which may be entered later in case control unit 40 comprises a self-learning system (see below).

In another embodiment, one or more of the liquid source sensors 21 are configured to sense the liquid temperature of the liquid source 20. As mentioned above, the control unit 40 is arranged to control the one or more vessel illumination colors of the plurality of vessel light sources 12 and optionally to control the intensity of the illumination from the plurality of vessel light sources 12 in dependence on the one or more liquid source sensing input signals, for instance the temperature. For instance, when hot water 27 is admixed to water 17 in bath 10, at least part of the total number of vessel light sources 12, especially those to which jet 27 is directed, may illuminate in another illumination color than vessel light sources 12 more remote from the liquid source 20 (i.e. vessel light sources 12 that in general are not hit by an undisturbed jet 27). For instance, when liquid 17 is illuminated with green light by vessel light sources 12, the vessel light sources 12 in the direction of jet 27 (usually under jet 27, indicated with area 19) may provide a red illumination. In this way, a local redly illuminated volume of liquid 17 is created. With increasing distance from the vessel light sources in the direction of jet 27 (i.e. with increasing distance from area 19), the color may gradually change from red to green. The control unit 40 may be configured to control the color gradient, i.e. to control the illumination color of the plurality of vessel light sources 12 in relation with the temperature of liquid 27, which is also based on additive or subtractive color mixing. The illumination color of the vessel light sources 12 may thus be adjusted to the temperature of the liquid of jet 27. To this end, control unit 40 may send output signals via carrier(s) 412 to the plurality of light sources 12, for controlling the illumination color and optionally the intensity, as function input signal(s) from one or more of: (1) one or more vessel sensors 11, (2) one or more liquid source sensors 21, and (3) user input device (51).

Hence, in an embodiment there is provided sanitary arrangement 1 further comprising one or more liquid source sensors 21 to obtain one or more liquid source sensing input signals, the one or more liquid source sensors 21 being configured to sense one or more of: liquid flux of the liquid source 20, liquid temperature of the liquid source 20 and color of the one or more liquid source light sources 22, and the control unit 40 being arranged to control the one or more vessel illumination colors of the plurality of vessel light sources 12 and optionally to control the intensity of the illumination from the plurality of vessel light sources 12 in dependence on the one or more liquid source sensing input signals. The sensing input signals of liquid source sensors 21 may be sent to control unit 40 via data carrier 421 (which may be wireless).

In yet a further embodiment, sanitary arrangement 1 according to the invention further comprises one or more vessel sensors 11 to obtain one or more vessel sensing input signals. The one or more vessel sensors 11 are configured to sense one or more of: liquid 17, vessel liquid temperature and movement in the vessel 10. The control unit 40 may then be arranged to control the one or more vessel illumination colors of the plurality of vessel light sources 12 and optionally to control the intensity of the illumination from the plurality of vessel light sources 12 in dependence on the one or more vessel sensing input signals. The sensing input signals of liquid source sensors 11 may be sent to control unit 40 via data carrier 411 (which may be wireless).

One or more sensors 11 may be configured to sense liquid (for instance at one or more places on wall 16 and/or bottom 15). The input signal generated by these sensors 11 and sent via carrier 411 to control unit 40 may be used by control unit 40 to send an output signal to vessel light sources 12 ordering them to illuminate only, or only in one or more specific illumination colors, when the specific sensors 11 are, or are not, in contact with liquid 17. In this way, the vessel sensors 11 and vessel light sources 12 may be arranged in vessel 10 and controlled by control unit 40 to illuminate in a different illumination color and/or at a different illumination intensity when in contact with liquid 17 or when not in contact with liquid 17. For instance, when the liquid source light sources 22 emit in a green color, the light sources in vessel 10 that are in contact with the liquid 17 received in the vessel may emit green light, whereas the other light sources 12 may emit white light or light of a color other than green, or emit green light, but with another intensity. In this way, also a filling effect may be achieved, in that when filling the vessel 10, the vessel light sources follow the rising or falling liquid surface of liquid 17 in vessel 10. Even waves in vessel 10 may (substantially simultaneously) be followed. Further, as will be clear to the person skilled in the art, one or more sensors 11 may be used to generate an input signal for controlling one or more vessel light sources 12 of the plurality of vessel light sources 12, i.e. a subset of vessel light sources 12 may be addressed. Preferably, these are the one or more vessel light sources 12 close to the one ore more sensors 11 arranged to sense liquid 17.

Such an effect may, in another embodiment, also be achieved or enhanced by using vessel 10 with transparent or translucent wall 16 and/or bottom 15, or transparent or translucent parts of wall 16 and/or bottom 15, the wall and/or bottom material being selected to have a ratio of transmission which, when in contact with liquid and compared to when not in contact with liquid, is larger than 1, preferably larger than 1.5, more preferably larger than 2. This means that the light of source 12 is transmitted through wall 16 or bottom 15 (or transparent or translucent part of wall 16 or bottom 15) more efficiently when the wall or part of wall through which source 12 illuminates liquid 17 is in contact with the liquid than when the wall or part of the wall is not in contact with liquid 17. In an embodiment, Corian® by DuPont may be applied. Similarly, an “emptying effect” can be achieved. As will be clear to the person skilled in the art, wall 16 or bottom 15 may be transparent or translucent only at positions where vessel sources 12 are arranged to illuminate liquid 17 through wall 16 or bottom 15.

For instance, the temperature effect described above with respect to the temperature of the liquid from liquid source 20 may likewise (alternatively or in addition to this above described effect) be applied as a function of the (local) temperature of liquid 17 in vessel 10. In this way, hotter regions and colder regions may be discerned. The executable instructions of control unit 40 may be defined such that vessel liquid 17 of a certain temperature has a certain color or a certain temperature that is related to a certain illumination intensity. Control unit 40 controls the one or more vessel illumination colors of the plurality of vessel light sources 12 by addressing one or more of the plurality of vessel light sources individually by output signals from the control unit via data carrier 412 to the light sources 12.

In addition, the above described impression of color mixing in vessel 10 may be enhanced by the use of movement sensors in vessel 10 and/or above vessel 10. To this end, vessel 10 may comprise one or more vessel sensors 11 to obtain one or more vessel sensing input signals, at least part of the total number of vessel sensors 11 being configured to sense movement in the vessel 10. Likewise, above vessel 10 one or more external sensors 61 may be arranged to obtain one or more vessel sensing input signals, at least part of the total number of external sensors 61 (for instance color cameras, etc.) being configured to sense movement in the vessel 10. Input signals generated by these sensors 11 and 61, respectively, may be communicated via data carriers 411 and 461, respectively, to control unit 40. The sensors 11 and/or 61 could regulate the vessel lighting by vessel lights 12 as a function of movements of a user in vessel 10. For instance, movements may be sensed by sensors 11 and/or 61 when a user's hand is moving in bath 10 to mix water (und thus, in an embodiment, to mix colors) or in the case of children playing in the bath water 17. User input device 51 may therefore also be configured to generate an input signal for control unit 40, determining whether the vessel illumination by vessel light sources 12 is to be related to movements sensed by sensors 11 and/or 61.

Hence, in a further embodiment, the liquid in the vessel 10 is illuminated by vessel light sources 12 of different colors, and when movement in the vessel 10 is sensed, colors are admixed (as a result of the instructions from the control unit 40 to the individual vessel light sources 12) as a function of this movement. Colors may be mixed based on subtractive or additive color mixing, as described above. The mixing may be defined in such a way that it appears to the user as natural mixing of colors (for instance of dyes). The way the colors are mixed is defined by the executable instructions from control unit 40.

A further advantage of sensors 11 or 61 or both may be that a simple analysis in the controller of the sensor information may also be used in a learning system to yield the approximate coordinates of the liquid source position.

In an embodiment, the color may spread from the liquid source as the starting point. In another embodiment, the color may further spread from bath to wall tiles and/or environmental lighting. To this end, in the schematical drawing external light sources 62 are shown. To give an example, liquid 27 from liquid source 20 is illuminated with red light, the bath water just below the jet is also illuminated with red light, but at a larger distance the illumination color changes, preferably gradually, from red to turquoise blue by illumination from vessel sources 12. External sources 62 may provide less deep-blue light, for instance aqua blue. Hence, control unit 40 may, in an embodiment, also control the color and or illumination intensity of external sources 62, by providing an output signal to external sources 62 via data carrier 462. Herein “external” especially refers to light sources which are not arranged on or in liquid source 20 and are not arranged in or on vessel 10.

Hence, the invention provides vessel 10 which may be illuminated by one or more (remotely) controlled multicolor light sources 12 that may be employed as individually and independently controllable devices, or coupled together to form a remotely controlled networked lighting system to provide a variety of programmable and/or coordinated color illumination effects in the sanitary arrangement according to the invention.

In an embodiment, the arrangement 1 may comprise more than one liquid source 20. In such embodiments, additional color mixing effects may be achieved. There may not only be a relationship between the liquid source illumination color of one or more liquid sources 22 and the illumination color of a part of the total number of vessel light sources 12, but there may also be one or more color mixing effects between the one or more parts of the total number of vessel light sources 12. For instance, a first liquid source 20 may provide a first liquid 17 that is illuminated with yellow light, and a second liquid source 20 may provide a second liquid 17 that is illuminated with red light, and the vessel light sources 12 may illuminate with white light. When opening the liquid sources 20, a color gradient may be formed from first area 19 in the direction of the first liquid source jet 27, with yellow light emitting light sources 12 fading to white light with increasing distance from first area 19 (preferably based on the principle of color mixing). Likewise, a color gradient may be formed from second area 19 in the direction of the second liquid source jet 27, with red light emitting light sources 12 fading to white light with increasing distance from second area 19 (preferably based on the principle of color mixing). However, vessel light sources arranged between the first and second areas 19 may emit colors that represent color mixing between yellow of the first area and red of the second area, i.e. from the first to the second area, the illumination from light sources 12 emits colors ranging from yellow through orange to red with increasing distance from first area 19 and decreasing distance to second area 19 (assuming subtractive color mixing). Other effects may also be realized. Also more than two liquid sources 20 may be used, as will be evident to the person skilled in the art.

In an embodiment, user input device 51 may also be configured to control the liquid flux of liquid source 20.

According to another aspect of the invention, a control unit 40 for use in a sanitary arrangement 1 is provided. Here, sanitary arrangement 1 comprises vessel 10 arranged to receive liquid 17, vessel 10 comprising a plurality of vessel light sources 12 configured to illuminate liquid 17 received in vessel 10, the plurality of vessel light sources 12 providing light of one or more vessel illumination colors, and the vessel source illumination colors of the plurality of vessel light sources 12 being controllable, said sanitary arrangement 1 further comprising liquid source 20, arranged to provide jet of liquid 27 to vessel 10, liquid source 20 comprising one or more liquid source light sources 22 configured to illuminate jet of liquid 27 from liquid source 20, the one or more liquid source light sources 22 providing light of a liquid source illumination color, and the liquid source illumination color of the one or more liquid source light sources 22 being controllable. According to this embodiment, the invention provides for this sanitary arrangement 1 control unit 40, which comprises a memory 201 with executable instructions, an input-output unit 202 configured to receive one or more input signals from one or more devices selected from the group consisting of (1) one or more vessel sensors 11, (2) one or more liquid source sensors 21, and user input device 51, and send one or more output signals to control the one or more vessel illumination colors of the plurality of vessel light sources 12 and optionally to control the intensity of the illumination from the plurality of vessel light sources 12, as well as a processor 203 designed to process the one or more input signals into one or more output signals, based on the executable instructions. Addressing the vessel light sources 12 by control unit 40 may include individually addressing the individual vessel light sources 12 of the plurality of light sources 12. Optionally, input-output unit 202 may further be configured to receive one or more input signals from one or more external sensors 61.

In a specific embodiment of control unit 40, the executable instructions define a relationship between the illumination colors of the plurality of vessel light sources 12 and the illumination color of the one or more liquid source light sources 22, as defined above. User input device 51 may be used to select the desired relationship by an input signal to control unit 40 (via data carrier 451). As described above, the relationship may be between the illumination color of the liquid light sources 22 and at least part of the total number of vessel light sources 12.

Further, in an embodiment, input-output unit 202 is further configured to send one or more output signals to control the source illumination color of the one or more liquid source light sources 22 and optionally to control the intensity of the illumination from the one or more liquid source light sources 22. Optionally, in an embodiment, input-output unit 202 is further configured to send one or more output signals to control the source illumination color of the one or more external light sources 62 and optionally to control the intensity of the illumination from the one or more external light sources 62. Further, in an embodiment, the illumination intensity of the vessel light sources 12 and the liquid source light sources 22 may be related. For instance, the user may simultaneously dim the illumination intensity of the sources 12 and 22.

According to a further aspect of the invention, a method for controlling one or more vessel illumination colors of a plurality of vessel light sources 12 and optionally for controlling the intensity of the illumination from the plurality of vessel light sources 12 of the sanitary arrangement 1 according to the invention is provided. This method comprises receiving sensing input signals from one or more devices selected from the group consisting of (1) one or more vessel sensors 11, (2) one or more liquid source sensors 21 and (3) user input device 51, the method further comprising deriving one or more output signals, the one or more output signals controlling the one or more vessel illumination colors of the plurality of vessel light sources 12 and optionally the intensity of the illumination from the plurality of vessel light sources 12, and the illumination colors of the plurality of vessel light sources 12 having a relationship with the illumination color of the one or more liquid source light sources 22; and the method comprising supplying the one or more output signals to the plurality of vessel light sources 12 of the sanitary arrangement 1.

In a specific embodiment of the method of the invention, the user may generate an user input signal with user input device 51, wherein the user input signal controls the liquid source illumination color of the one or more liquid source light sources 22, and wherein the method further comprises sensing the user input signal, deriving one or more output signals for controlling the liquid source illumination color of the one or more liquid source light sources 22, and supplying the one or more output signals to the of the one or more liquid source light sources 22. As mentioned above, the relationship is preferably based on additive or subtractive color mixing.

According to yet another aspect, the invention provides a computer program product comprising executable instructions, which instructions when executed on a processor perform the method according to the invention.

For purposes of the present disclosure, the term “vessel” is used generally to describe a bath or other vessel containing a water (or other liquid), that may be used for any number of utilitarian, entertainment, recreational, therapeutic, or sporting purposes. It may include any type of bath for use at home or in recreation areas, such as a “hot-tub,” a “swimming pool”, a “whirlpool bath” and a “Jacuzzi”. As used herein, a vessel may be for human use (e.g., swimming, bathing, cleaning) or may be particularly designed for use with wildlife (e.g., an aquarium for fish, other aquatic creatures, and/or aquatic plant life). Additionally, a vessel may be man made or naturally occurring and may have a variety of shapes and sizes. Hence, the sanitary arrangement may further comprise springs, fountains, spa's etc., wherein one or more light sources illuminate the liquid flowing or welling into a (natural) basin or channel, and wherein a plurality of light sources illuminate the liquid received in the (natural) basin or channel. Hence, although the invention is especially directed to sanitary arrangements, such as shower arrangements, bath arrangements, wash basins, bidets, lavatories, etc. the invention may be interpreted broader. The principle of the invention can be applied to any source-vessel arrangement for liquids, wherein the source provides a liquid that is received by a vessel, and wherein the liquid jet produced by the source can be illuminated and wherein the liquid received by the vessel can be illuminated.

Furthermore, a vessel may be constructed above ground or below ground, and may have one or more discrete walls or floors, one or more rounded surfaces, or combinations of discrete walls, floors, and rounded surfaces. Accordingly, it should be appreciated that the term “vessel” as used herein is intended to encompass various examples of water containing vessels such as, but not limited to, tubs, sinks, basins, baths, tanks, pools, fish tanks, aquariums and the like, but as mentioned above, also basins, baths, wash basins, bidets, and lavatories. The vessel may include a number of accessory devices, such as one or more heaters, blowers, jets, circulation and filtration devices to condition water in the vessel. For purposes of the present disclosure, it also should be appreciated that a vessel as described above may be divided up into one or more sections, and that one or more of the pool sections can be particularly adapted for use as a spa. The source will in general be one or more taps or shower heads, but may also comprise (natural) springs, fountains, spa's etc. One or more liquid sources 20 may be arranged in such a way, that when vessel 10 fills with liquid 17, liquid 27 of liquid source 20 fills vessel 10 below the liquid surface, i.e. the opening(s) of liquid source(s) 20 are (temporarily) below the liquid surface. Liquid source light sources 22 are arranged to illuminate jet 27 when liquid source 20 provides the jet of liquid 27.

As will be clear to the person skilled in the art, the light sources, sensors, control unit may comprise one or more suitable energy sources. Data carriers 421, 42, 451, 452, 461, 462 may be contact wires or may include wireless communication.

Further, the vessel may contain one or more compartments, one or more overflows, one or more discharges (for instance in bottom 15), etc.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A sanitary arrangement with controllable illumination of liquid, the arrangement comprising:
(i) a vessel for receiving the liquid therein; the vessel comprising a plurality of vessel light, sources configured to controllably illuminate the liquid received in the vessel, wherein the plurality of vessel light sources provide light of one or more variable vessel illumination colors;
(ii) a liquid source providing a jet of liquid for supplying the liquid to the vessel; the liquid source comprising one or more liquid source light sources configured to controllably illuminate the jet of liquid wherein the one or more liquid source light sources provide light of a variable liquid source illumination color; and
(iii) a control unit configured to control the plurality of vessel light sources so as to vary the one or more vessel illumination colors in coordination with the illumination color of the one or more liquid source light sources.

2. The sanitary arrangement according to claim 1, further comprising a user input device, configured to receive a user input signal for controlling the liquid source light source so as to vary at least one of the liquid source illumination color and the illumination intensity of the liquid source light source.

3. (canceled)

4. The sanitary arrangement according to claim 1, further comprising one or more liquid source sensors for sensing at least one of: liquid flux of the liquid source, temperature of the liquid supplied by the light source, and color of light provided by the one or more liquid source light sources and generating one or more source sensing input signals in response thereto, and wherein the control unit controls the plurality of vessel light sources so as to vary at least one of the one or more vessel illumination colors and the intensity of the illumination from the plurality of vessel light sources based at least in part on the one or more source sensing input signals.

5. The sanitary arrangement according to claim 1, further comprising one or more vessel sensors for sensing vessel liquid temperature and/or movement of the liquid in the vessel and generating one or more vessel sensing input signals in response thereto, and wherein the control unit controls the plurality of vessel light sources so as to vary at least one of the one or more vessel illumination colors and the intensity of the illumination from the plurality of vessel light sources based at least in part on the one or more vessel sensing input signals.

6. The sanitary arrangement according to claim 1, wherein the vessel is selected from the group consisting of: a shower basin, a bath, a wash basin, a bidet, and a lavatory.

7. The sanitary arrangement according to claim 1, wherein the liquid comprises water.

8. A control unit for controlling illumination of liquid in a sanitary arrangement comprising:
a vessel for receiving the liquid therein; the vessel comprising a plurality of vessel light sources configured to controllably illuminate the liquid received in the vessel, wherein the plurality of vessel light sources provide light of one or more variable vessel illumination colors; and
a liquid source providing a jet of liquid for supplying the liquid to the vessel; the liquid source comprising one or more liquid source light sources configured to controllably illuminate the jet of liquid, wherein the one or more liquid source light sources provide light of a variable liquid source illumination color,
the control unit comprising:
(i) a memory for storing executable instructions defining a relationship between the illumination colors of the plurality of vessel light sources and the illumination color of the one or more liquid source light sources;
(ii) a processor for processing the one or more input signals into one or more output signals, based on the executable instructions; and
(iii) an input-output unit configured to (i) receive one or more input signals from one or more devices selected from the group consisting of: one or more vessel sensors one or more liquid source sensors and a user input device; and (iii) send one or more output signals to control the plurality of vessel light sources so as to vary, in coordination with the illumination color and/or the intensity of the one or more liquid source light sources, at least one the one or more vessel illumination colors the intensity of the illumination from the plurality of vessel light sources.

9. The control unit according to claim 8, wherein the input-output unit is further configured to send one or more output signals to control the source illumination color of the one or more liquid source light sources and the intensity of the illumination from the one or more of liquid source light sources.

10. A method tor controlling illumination of liquid in a sanitary arrangement comprising:
a vessel for receiving the liquid therein; the vessel comprising a plurality of vessel light sources configured to controllably illuminate the liquid received in the vessel, wherein the plurality of vessel light sources provide light of one or more variable vessel illumination colors; and
a liquid source providing a jet of liquid for supplying the liquid to the vessel; the liquid source comprising one or more liquid source light sources configured to controllably illuminate the jet of liquid, wherein the one or more liquid source light sources provide light of a variable liquid source illumination color,
the method comprising:
(i) receiving sensing input signals from one or more devices selected from the group consisting of: one or more vessel sensors, one or more liquid source sensors, and a user input device;
(ii) deriving one or more output signals, wherein the one or more output signals control the plurality of vessel light sources so as to vary, in coordination with the illumination color and/or the intensity of the one or more liquid source light sources, at least one of one or more vessel illumination colors and the intensity of the illumination from the plurality of vessel light sources; and
(iii) supplying the one or more output signals to the plurality of vessel light sources of the sanitary arrangement.

11. The method according to claim 10, further comprising: generating a user input signal via the user input device to control the one or more liquid source light sources so as to vary the liquid source illumination color; and sensing said user input signal, wherein the plurality of vessel light sources are controlled so as to vary the one or more vessel illumination colors to substantially match the illumination color of the one or more liquid source light sources.

12-13. (canceled)

14. The sanitary arrangement according to claim 1, wherein the control unit controls the plurality of vessel light sources so as to vary the one or more vessel illumination colors to substantially match the illumination color of the one or more liquid source light sources.

15. The control unit according to claim 9, wherein the plurality of vessel light sources are controlled so as to vary the one or more vessel illumination colors to substantially match the illumination color of the one or more liquid source light sources.
